(19) United States
(12) Patent Application Publication
(10) Pub. No.: US 2021/0133850 A1
(43) Pub. Date: May 6, 2021

(54) MACHINE LEARNING PREDICTIONS OF RECOMMENDED PRODUCTS IN AUGMENTED REALITY ENVIRONMENTS

(71) Applicant: ADOBE INC., San Jose, CA (US)

(72) Inventors: Kumar Ayush, Jharkhand (IN); Harnish Naresh Lakhani, Maharashtra (IN); Atishay Jain, Delhi (IN)

(73) Assignee: ADOBE INC., San Jose, CA (US)

(21) Appl. No.: 16/675,606

(22) Filed: Nov. 6, 2019

(51) Int. Cl. G06Q 30/06; G06N 20/00; G06N 5/04; G06K 9/00; G06K 9/20; G06K 9/62

(52) U.S. Cl. CPC G06Q 30/0631; G06N 20/00; G06K 9/6256; G06K 9/00671; G06K 9/2054; G06N 5/04

(57) ABSTRACT

Techniques for providing a machine learning prediction of a recommended product to a user using augmented reality include identifying at least one real-world object and a virtual product in an AR viewpoint of the user. The AR viewpoint includes a camera image of the real-world object(s) and an image of the virtual product. The image of the virtual product is inserted into the camera image of the real-world object. A candidate product is predicted from a set of recommendation images using a machine learning algorithm based on, for example, a type of the virtual product to provide a recommendation that includes both the virtual product and the candidate product. The recommendation can include different types of products that are complementary to each other, in an embodiment. An image of the selected candidate product is inserted into the AR viewpoint along with the image of the virtual product.

### FIELD OF THE DISCLOSURE

This disclosure relates to the field of augmented reality, and more particularly, to techniques for machine learning predictions of recommended products by augmenting a digital image of an augmented reality environment with an image of a recommended product.

### BACKGROUND

Augmented reality (“AR”) is an environment in which virtual, computer-generated objects are concurrently displayed with physical, real-world scenes. An AR user device, which can include a camera for obtaining an image of the real-world scene and an electronic display, can be used to display the image of the real-world scene augmented with images of virtual objects that are not physically present in the scene but are made to appear as if they are present. In this manner, a user can easily visualize the scene with a variety of non-existent objects. For example, the user can use an AR device to see how various pieces of furniture would look in their home without having to obtain and physically place the actual pieces in the room. In some cases, the user can interact with the AR device to change or manipulate one or more virtual objects in the AR environment. For example, the user can change the position and orientation of the virtual objects (e.g., furniture) within the real-world scene (e.g., user's living room) on the AR device. Furthermore, various machine learning prediction techniques can utilize AR to select and display virtual objects based on the types of objects already present in the AR environment. Specifically, the type of virtual objects selected for display are of the same type as the type of objects currently displayed. So, for instance, if a given virtual scene includes a couch, then the machine learning prediction will include a different couch (i.e., the same type of object). However, such existing recommendation techniques do not fully utilize all the information available in the AR environment, thus limiting the potential breadth of machine learning predictions to products of the same type selected by the user.

### BRIEF DESCRIPTION OF THE DRAWINGS

FIG. 1 is a block diagram of an example system for machine learning predictions of recommended products in an AR environment, in accordance with an embodiment of the present disclosure.

FIG. 2 is a graphic representation of a camera image of a real-world environment, in accordance with an embodiment of the present disclosure.

FIG. 3 is a graphic representation of a viewpoint of an AR environment which includes the real-world environment of FIG. 2 and a virtual object that has been virtually placed in that real-world environment, in accordance with an embodiment of the present disclosure.

FIG. 4A is a graphic representation of a machine learning prediction showing diverse product types in an AR environment, in accordance with an embodiment of the present disclosure.

FIG. 4B is a graphic representation of another viewpoint of an AR environment which includes the real-world environment of FIG. 2 and the recommended product bundle of FIG. 4A, in accordance with an embodiment of the present disclosure.

FIG. 5A is a graphic representation of another machine learning prediction showing diverse product types in an AR environment, in accordance with an embodiment of the present disclosure.

FIG. 5B is a graphic representation of yet another viewpoint of an AR environment which includes the real-world environment of FIG. 2 and the machine learning prediction of FIG. 5A, in accordance with an embodiment of the present disclosure.

FIGS. 6A and 6B show flow diagrams of an example process for machine learning predictions of recommended products in an AR environment that provides a diverse range of product types, in accordance with an embodiment of the present disclosure.

FIG. 7 shows several example potential viewpoints of another example AR environment which includes a real-world environment and a virtual object that has been virtually placed in that real-world environment, in accordance with an embodiment of the present disclosure.

FIGS. 8A and 8B show an example viewpoint selection for which a user can view machine learning predictions of recommended products in an AR environment, in accordance with an embodiment of the present disclosure.

FIG. 9 shows an example bounding box, in accordance with an embodiment.

FIG. 10A shows bounding boxes representing physical objects, in accordance with an embodiment of the present disclosure.

FIG. 10B shows a bounding box representing virtual objects, in accordance with an embodiment of the present disclosure.

FIG. 11 shows two example virtual objects that can be selected for inclusion in the machine learning prediction, in accordance with an embodiment of the present disclosure.

FIGS. 12, 13, 14, 15, 16 and 17 are example viewpoints in an AR environment that includes machine learning predictions of recommended products virtually placed in a viewpoint, in accordance with an embodiment of the present disclosure.

### DETAILED DESCRIPTION

Techniques for providing a machine learning prediction of recommended products to a user using augmented reality include identifying at least one real-world object and at least one virtual product in an AR viewpoint of the user. According to an embodiment, the machine learning prediction includes at least one type of product that is complementary to the virtual product (rather than repetitive or redundant to the virtual product). So, for instance, if the AR viewpoint includes an actual couch and chair set, along with a virtual coffee table, then the machine learning prediction may include a lamp and/or a vase. In this manner, these techniques can be used to allow customers to visualize not only products that they are considering purchasing, but also products that are functionally or stylistically complementary to the virtual product. The AR viewpoint includes a camera image of the real-world object(s) and an embedded image of the virtual product, which is chosen by the user. The embedded image of the user-selected virtual product is inserted into the camera image of the real-world object, to provide the AR viewpoint. A candidate product that is complementary to the user-selected virtual product is then machine-selected (i.e., machine-predicted) to provide a product bundle that includes both the virtual product and the candidate product. The machine learning prediction underlying the selection can thus include different types of products, such as a vase and a lamp, to complement the earlier user-selected coffee table. An image of the machine-selected) candidate product can thus be inserted into the AR viewpoint along with the previously embedded user-selected image of the virtual product, thereby effectively providing a viewable machine learning prediction to the user. The user can thus readily visualize the candidate products along with the real-world objects and virtual products in the AR viewpoint. In addition to complementary products, candidate products may also include (or alternatively include) products of the same type as the user-selected virtual product, but that are different with respect to one or more attributes, such as a couch having a color and/or fabric pattern that better matches or otherwise complements the surroundings in the real-world scene captured in the AR viewpoint. In either case, note that candidate products included in the machine learning prediction are based on details captured in the AR viewpoint. Further note that candidate products are referred to herein as being machine-selected or machine-predicted or machine-inferred, given that machine learning is used to select such products.

General Overview

Augmented reality can be used to enhance a customer's shopping experience for various products. In general, an AR device is configured to provide an AR environment in which virtual objects correspond to physical, real-world objects that are available for sale. The virtual objects can be virtually placed into an imaged physical environment to augment the customer's viewpoint in that physical environment. The augmented environment is generally referred to as an AR environment herein. The AR device further allows customers to interact with the AR environment as they shop for products. In particular, if the customer is shopping for a table, the AR device can display an image of the table the customer is considering in a scene of a room so that the user can see what the table looks like in the room before making a purchasing decision. The user may further manipulate the virtual table within the AR environment, or view it from different angles. Thus, the AR environment provides an engaging way for a consumer to visualize a product in a real-world scene to judge the compatibility and desirability of the product before making a purchase. One example is the use of a mobile phone's camera or a laptop's webcam to virtually try on clothes or sunglasses before purchasing them. Another example is an AR application that allows a consumer to place and visualize virtual furniture in her room using her mobile phone. However, existing techniques fail to realize the full potential of AR as they do not robustly leverage the visual data obtained from such applications to build intelligent solutions over it. For instance, there are no AR tools that provide machine learning predictions of products that are complementary to the virtual product in the AR environment, or products otherwise absent from the AR environment. Therefore, there is a need for techniques that: a) create richer, more diverse machine learning predictions based on the absence of certain product types in the viewpoint as well as the association of those product types with the real-world and virtual objects already present in the viewpoint; and b) create personalized catalogues by embedding recommended product bundles in the viewpoint.

To this end, in accordance with certain embodiments of the present disclosure, the rich dataset of the AR environment is used to provide machine learning predictions that are more engaging and more persuasive than those obtained from, for instance, web browsing data or from existing AR techniques that do not consider omissions and/or other data that can be inferred from the AR environment. For instance, visual data, including an initial user-selected and placed virtual object, is identified in an AR environment, and is used to infer or otherwise predict additional existing objects/products that are one or both of (1) missing in, or (2) complementary to, the user's physical world surroundings. These predicted additional products are used to augment the AR environment, and thus provide persuasive and personalized machine learning predictions to the user. Furthermore, such machine learning predictions can have a high association or be complementary with the identified objects and/or features captured in the viewpoint, thus making these machine learning predictions highly relevant and appealing to the user. In addition, or alternatively, any visual data included in the AR environment can be used to identify a variant of the initially user-selected virtual object, such that the variant is complementary to the other visual data in the AR environment. This level of personalization in machine-based recommendations has not been achieved before and will make machine learning predictions more engaging and provide a richer product set for inclusion in the AR environment.

In further detail, certain embodiments of the present disclosure provide an AR application that simulates an AR environment by recognizing a physical object in an image of a physical, real-world scene. The AR application supplements or augments the scene by displaying a virtual object along with the physical object, and further augments the scene with other additional products that functionally or stylistically complement the virtual object to provide the user with one or more images of products in a machine learning prediction, according to an embodiment. For example, if the physical object is a sofa, a virtual coffee table can be displayed to supplement the scene so that the user can see what the space will look like with the table. In addition, or alternatively, if the physical object is a sofa, a virtual variant of that sofa (e.g., such as the same sofa but with a different fabric pattern and/or color) can be displayed to show the user what the space will look like with that variant, wherein the variant is machine-selected based on it being complementary to one or more other features captured in the AR environment (e.g., such as complementary to the fabric pattern and/or color of the window dressings). In the AR environment, a virtual object corresponds to a real-world physical object that may be available for sale. In this example, the AR device detects user input as the user interacts with the AR environment, such as, for example, when the user changes her viewpoint of the scene, when the user changes the virtual object (e.g., such as by changing the location of the table, or by changing the viewing angle of the AR environment to see what the table looks like from different perspectives), or when the user requests information about the virtual object (e.g., such as a request for information about a price or an availability of the corresponding real-world physical object, or a request to purchase the corresponding real-world object). The AR device also analyzes and stores the detected user input.

Further, the AR device can display additional products that functionally or stylistically complement the virtual product based on the types of real-world objects and/or the types of virtual products displayed in the AR viewpoint of the user. Combinations of complementary virtual products are referred to as product bundles, according to some example embodiments. The AR device generates and displays visual information representing the physical space or environment, the physical object, the virtual object, the machine learning prediction of one or more additional virtual objects, or any combination of these in response to the detected user input. Numerous embodiments and applications will be appreciated in light of this disclosure.

### General Terminology

As used herein, in addition to its plain and ordinary meaning, the phrase “augmented reality” (“AR”) generally refers to any technology that augments a first image of a real-world scene with a second image by superimposing the second image onto the image of the real-world scene. For example, using AR technology, an image of an object may be superimposed on an image of a user's view of the real world, such as in an image of a physical space captured by a camera on the user's mobile phone or other imaging device.

As used herein, in addition to its plain and ordinary meaning, the phrase “camera image” generally refers to an image of any scene or object captured by a camera of a real-world scene including or excluding any images superimposed onto the image. The camera image includes, for example, a view of the physical, real-world objects as captured by the camera but does not contain any augmented objects or images. The camera image can be augmented to include one or more images of virtual objects and can be displayed on a display of a user device with or without any virtual object images.

As used herein, in addition to its plain and ordinary meaning, the phrase “virtual product” refers to a digital representation of a product, such as an image (e.g., camera image or a digital three-dimensional model) of a product for sale, or other object. An image of the virtual product can be inserted, superimposed on, and/or integrated into a camera image using augmented reality technology. The virtual product, for example, can include a digitized image of an actual, physical product, or other digital representation of an actual product, such as a digitized sketch, drawing, or photograph of the product. In certain examples, the virtual product can have three-dimensional properties and can be viewed, analyzed, and manipulated in AR as a three-dimensional object. An image of the virtual product can be viewed, for example, on the display screen of the user device when the user utilizes a camera application on the user device to generate a camera image, and then places the image of the virtual product in the camera image. As a result, the image of the virtual product appears on the display of a user device as a virtual object and can be positioned in the display relative to the real-world objects in the user's surroundings that are also presented to the user on the display of the user device. Note that an image need not be limited to a camera image but may include any digital representation of an object or product, including three-dimensional models.

As used herein, in addition to its plain and ordinary meaning, the term “viewpoint” refers to a view captured in a camera image taken at a given instant in time that represents a potential perspective of a user with respect to the real-world scene in the camera image. In addition to the camera image, which can include real-world objects and scenes, the viewpoint may further include one or more virtual objects or products that are virtually present in the camera image. A given viewpoint can be determined, for example, by detecting that the user interactions indicate that the user has finished positioning a virtual product within a camera image of a given scene and in a desired location among the real-world objects captured in the scene, as viewed in the camera image. For example, the viewpoint can be determined when the user stops re-positioning the virtual product in the AR environment for longer than a certain amount of time (for example, as captured by a binary variable in the AR system) and/or without moving the computing device (for example, as captured by accelerometer data of the device).

As used herein, in addition to its plain and ordinary meaning, the phrase “real-world object” refers to actual, physical items. A real-world object can be physically present in a user's surroundings and appear in a camera image of those surroundings. Real-world objects include, for example, tables, desks, chairs, sofas, benches, sculptures, artwork, lamps, flooring, painted walls, wall hangings, rugs, electronic devices, or any other object that can be placed into the user's surroundings. Practically speaking, there are almost an infinite number of real-world objects that might be in a given environment, and the few examples provided here are not intended to limit the present disclosure, as will be appreciated.

As used herein, in addition to its plain and ordinary meaning, the phrase “candidate product” refers to a product that is different than a virtual product that the user has selected but is nevertheless a product that the user may be interested in purchasing. The candidate product can be the same type of product as the virtual product but have some variation (such as different color or fabric), or it can be a different type of product that is complementary to the user-selected product or otherwise inferred to be of interest to the user. Note that, in either case, the candidate product is machine-selected as being complementary to the AR environment, whether it be a different product type that is complementary to the virtual product type, or a variant of the virtual product that is complementary to other aspects captured in the AR environment. For example, if the virtual product is a user-selected table, the candidate product can be a lamp or vase that complements the table. In this example, the candidate product is a different type of product from the virtual product. The candidate product can be represented in an AR environment as a digital image, a three-dimensional virtual model of an actual product, or other rendering of an actual product. The candidate product is recommended to the user, which is in contrast to the virtual product, which is specifically selected by the user. In certain examples, the candidate product has three-dimensional features and can be manipulated to various positions and poses, such as by rotating the candidate product and/or moving the candidate product within the AR environment. For example, if a user is interested in a chair and selects a chair as a virtual product to augment the AR environment, a digital representation of a candidate product that is different from the user-selected chair but functionally or stylistically complementary to the user-selected chair and/or other aspects of the AR environment can be machine-selected to further augment the AR environment and thus presented to the user as a possible further product of interest. In certain examples, the candidate product image may be an image of the same chair that the user initially selected, except in a different color (or some other variation) that is more soothing based on the color patterns, hues, and tones present in the camera image. Candidate product images (including any models), for example, can be stored in an image repository and can be selected for inclusion in a recommendation image as described herein.

As used herein, in addition to its plain and ordinary meaning, the phrase “recommendation image” refers to a camera image from a user that that has been augmented to include a candidate product image. The recommendation image is, for example, based on the viewpoint of the user, and includes real objects captured in the camera image present from the user's surroundings. In the recommendation image, the candidate product image can be placed, for example, adjacent a user-selected virtual product present in the viewpoint (so as to complement the user-selected virtual product), or in the same or similar location and orientation of the user-selected virtual product that was present in the viewpoint so as to provide an alternative version (variant) of that user-selected virtual product (e.g., different color or fabric pattern).

As used herein, in addition to its plain and ordinary meaning, the phrase “product bundle” refers to a set of products including one or more virtual products and one or more candidate products. The product bundle can include different types of products that are complementary to each other, such as a table and a lamp, as will be appreciated in light of this disclosure. A “product bundle recommendation” refers to a product bundle that is determined, using the techniques described in this disclosure, to be relevant to the user based on the user's interaction with the AR environment.

As used herein, in addition to its plain and ordinary meaning, the phrase “style similarity” refers to a measure of the likeness between two products, such as likeness of product shape, pattern, and/or features. Style similarity of products can be measured using various techniques. Style similarity can be determined quantitatively, for example, such as by using style similarity metrics of three-dimensional products. For example, style similarity between two products can be determined based on the level of matching between the products and the prevalence of the similar areas. Style similarity can be assessed using machine learning techniques trained based on a training set of images of similar objects. Such techniques generally identify similarity of features in three-dimensional models of the two products and determine how similar the two products are based on the amount of matching features in the two products.

As used herein, in addition to its plain and ordinary meaning, the phrase “color compatibility” refers to a measure of how well colors in a color scheme go together. Color compatibility can be measured using various techniques. Color compatibility can be determined quantitatively, such as by sampling the colors in a recommendation image and comparing the sampled colors to known color compatibility schemes. One exemplary technique determines a set of harmonious color schemes by receiving rankings or other evaluations of color schemes from multiple users and identifying the color schemes with the highest average rankings or evaluations. The color compatibility of other color schemes is then determined by determining how similar the other color schemes are to the known harmonious color schemes. If a color scheme has colors similar to a harmonious color scheme, the color scheme is given a relatively high color compatibility score. If a color scheme has colors that are not similar to any of the harmonious color schemes, the color scheme is given a relatively low color compatibility score. In one example, a color scheme of a recommendation image is determined to contain colors that are harmonious. Similar compatibility can be determined with respect to other attributes, such as texture and shapes.

System Architecture

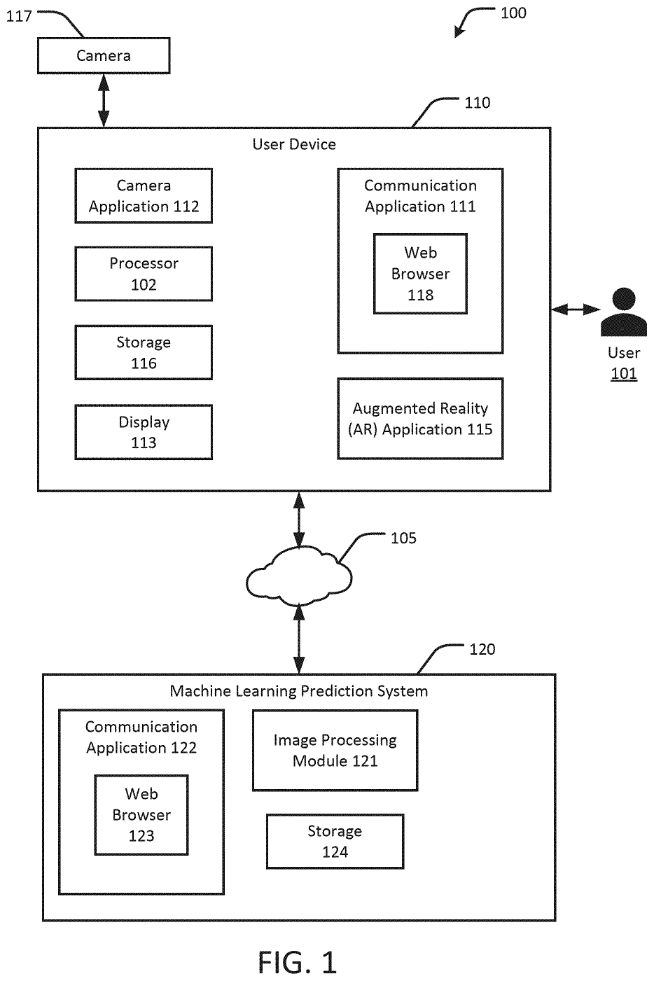

FIG. 1 is a block diagram of an example system 100 for generating machine learning predictions of recommended products by augmenting a digital image with an image of a recommended product, in accordance with an embodiment of the present disclosure. The system 100 includes a user device 110 and a machine learning prediction system 120 that are configured to interact with each other over a network 105.

The network 105 includes a wired or wireless telecommunication means by which the user device 110 and the machine learning prediction system 120 interact. For example, the network 105 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy, near field communication (“NFC”), Wi-Fi, or any combination thereof or any other appropriate architecture or system that facilitates the communication of signals, data, and/or messages. The user device 110 and the machine learning prediction system 120 are configured to transmit and receive data over the network 105. For example, the user device 110 and the machine learning prediction system 120 can include a server, desktop computer, laptop computer, tablet computer, a television with one or more processors 102 embedded therein and/or coupled thereto, smart phone, handheld computer, personal digital assistant (“PDA”), or any other wired or wireless, processor-driven device. The user device 110 and the machine learning prediction system 120 can be operated by end-users or consumers, recommendation system operators, and marketing operators, respectively, or other end user operators.

The user device 110 can include a communication application 111 and associated web browser 118 that can interact with web servers or other computing devices connected to the network 105. For example, the user 101 can use the communication application 111 of the user device 110, such as a web browser 118 application or a stand-alone application, to view, download, upload, or otherwise access documents, web pages, or digital images via a distributed network 105. For example, the user 101 may use the communication application 111 and web browser 118 to identify images of products on the internet that the user wishes to use, such as in conjunction with an augmented reality application 115, to augment a camera image displayed on the user device display 113 with the product using the augmented reality application 115.

The user device includes a camera application 112 that is configured to interact with a camera 117 of the user device 110 and a user device display 113. The camera application includes software and or/other components of the user device 110 that operate the camera 117. Using the camera application 112, the user 101 can, for example, zoom in, zoom out, and perform other features typically associated with using a camera 117 on a user device 110. The camera application 112 is also connected to a user device display 113, which represents the video screen on which the user views the output of the camera 117 as processed by the camera application 112. For example, if the user 101 points the camera of the user device 110 at a table, the table and its surroundings are visible to the user as an image in the user device display 113.

As previously noted, the user device 110 includes the augmented reality application 115. The augmented reality application 115 (“AR application”) represents the component of the user device 110 that, in certain example embodiments, allows a user 101 to augment a camera image on the user device display 113 with a virtual object. For example, if the user 101 selects an image of a product from the internet using the communication application 111, the AR application 115 allows the user 101 to insert the product in the camera image of the display 113 so that the user 101 can view the virtual object on the user device display 113 as a virtual product. The AR application is configured to interact with the camera 117, the camera application 112, and the camera image display 113 of the user device 110 to generate an augmented reality image (including the virtual product and the candidate product).

In certain embodiments, the user device 110 includes a data storage unit 116 for use in storing retrievable information, such as product images that the user 101 has collected with use with the AR application 115. For example, the user 101 can use the data storage unit to store product images of products that the user 101 may be interested in purchasing. The user 101 can then use the AR application 115, for example, to later retrieve a product image and superimpose the product image as a virtual object on a camera image generated via the camera 117, the camera application 112, and the camera image display 113. The example data storage unit 116 can include one or more tangible computer-readable media. The media can be either included in the user device 110 or operatively coupled to the user device 110. The data storage unit 116 can include on-board flash memory and/or one or more removable memory cards or removable flash memory.

The machine learning prediction system 120 is configured to determine a user viewpoint of an augmented reality image, determine the position of a virtual product in the camera image, create and evaluate machine learning predictions of recommended products and product bundles, and provide images of the recommended products and product bundles to the user 101 in an AR environment. The machine learning prediction system 120 includes an image processing module 121 configured to perform certain functions of the machine learning prediction system 120. In some embodiments, the image processing module 121 processes an image received from the user device 110 to determine the time instant for selecting the viewpoint. The image processing module 121 also processes the received imaged to create and evaluate the recommended products and product bundles.

The machine learning prediction system 120 further includes a communication application 122 and associated web browser 123. The communication application 122 is configured to permit the user 101 to interact with the machine learning prediction system 120. For example, the user 101 can use the web browser 123 to identify and create a repository of candidate products, such as by searching the web or using a web search engine to identify candidate products for inclusion with the recommended product bundle. The repository of candidate products can be stored on a data storage unit 124 of the machine learning prediction system 120. The data storage unit 124 can store recommendation images that can be retrieved, such as by the image processing module 121, and used to create a machine learning prediction. The example data storage unit 124 can include one or more non-transitory computer-readable media and can be either included in the machine learning prediction system 120 or operatively coupled to the machine learning prediction system 120. The data storage unit 124 can include on-board flash memory and/or one or more removable memory cards or removable flash memory.

It will be appreciated that any or all the functions of the machine learning prediction system 120 can be performed on the user device 110, such as in conjunction with (or as an integrated part of) the AR application 115. In some embodiments, one or more of the functions of the machine learning prediction system 120 can be performed separately and independently from the user device 110. For example, the machine learning prediction system 120 can receive augmented reality images and/or data from the user device 110, such as from the AR application 115 via the network 105. The machine learning prediction system 120 can process the received images and/or data and generate a machine learning prediction to the user 101 over the network 105 and via the user device 110. In another example, the viewpoint can be determined using the AR application 115, the machine learning prediction system 120, or both.

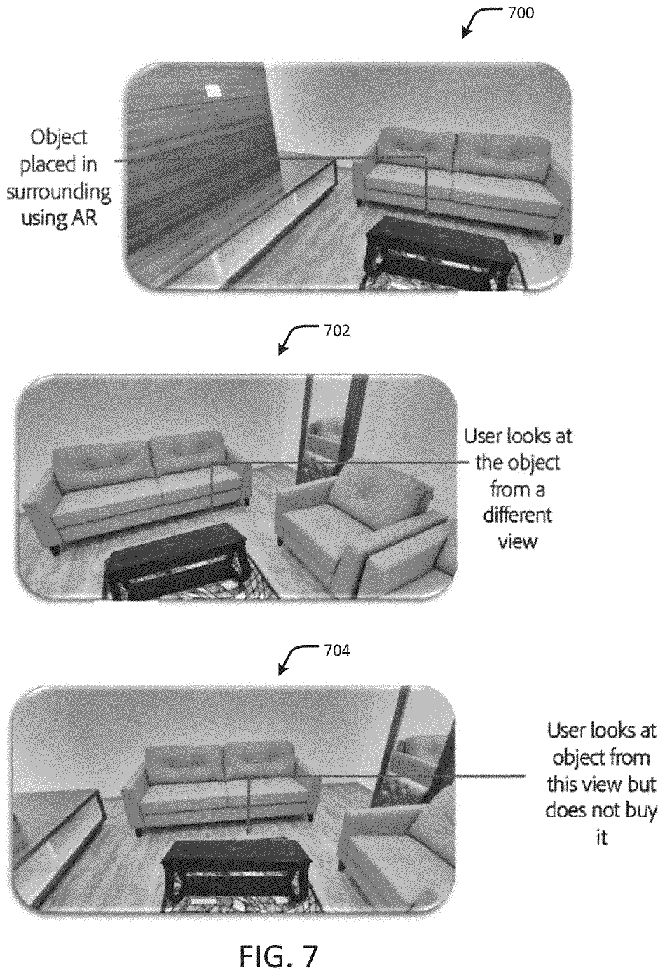

The user device 110 and the machine learning prediction system 120 can be used to perform any of the techniques as variously described in this disclosure. For example, the system 100 of FIG. 1, or any portions thereof, and the processes of FIGS. 6A and 6B, or any portions thereof, may be implemented in the system 100. The user device 110 and the machine learning prediction system 120 can include any computer system, such as a workstation, desktop computer, server, laptop, handheld computer, tablet computer (e.g., the iPad® tablet computer), mobile computing or communication device (e.g., the iPhone® mobile communication device, the Android™ mobile communication device, and the like), VR device or VR component (e.g., headset, hand glove, camera, treadmill, etc.) or other form of computing or telecommunications device that is capable of communication and that has sufficient processor power and memory capacity to perform the operations described in this disclosure. A distributed computational system may be provided including a plurality of such computing devices.

The data storage units 116 and 124 each include one or more storage devices or non-transitory computer-readable media having encoded thereon one or more computer-executable instructions or software for implementing techniques as variously described in this disclosure. The storage devices may include a computer system memory or random access memory, such as a durable disk storage (which may include any suitable optical or magnetic durable storage device, e.g., RAM, ROM, Flash, USB drive, or other semiconductor-based storage medium), a hard-drive, CD-ROM, or other computer readable media, for storing data and computer-readable instructions or software that implement various embodiments as taught in this disclosure. The storage devices may include other types of memory as well, or combinations thereof. The storage devices may be provided on the system 100 or provided separately or remotely from the system 100. The non-transitory computer-readable media may include, but are not limited to, one or more types of hardware memory, non-transitory tangible media (for example, one or more magnetic storage disks, one or more optical disks, one or more USB flash drives), and the like. The non-transitory computer-readable media included in the system 100 may store computer-readable and computer-executable instructions or software for implementing various embodiments. The data storage units 116 and 124 can be provided on the system 100 or provided separately or remotely from the system 100.

The system 100 also includes at least one processor 102 and 121 for executing computer-readable and computer-executable instructions or software stored in data storage units 116 and 124 or non-transitory computer-readable media and other programs for controlling system hardware. Virtualization may be employed in the system 100 so that infrastructure and resources in the system 100 may be shared dynamically. For example, a virtual machine may be provided to handle a process running on multiple processors so that the process appears to be using only one computing resource rather than multiple computing resources. Multiple virtual machines may also be used with one processor.

A user may interact with the system through the user display device 113, such as a screen, monitor, display, or printer, including an augmented reality display device, which may display one or more user interfaces provided in accordance with some embodiments. The display device 113 may also display other aspects, elements or information or data associated with some embodiments. The system 100 may include other I/O devices for receiving input from a user, for example, a keyboard, a joystick, a game controller, a pointing device (e.g., a mouse, a user's finger interfacing directly with a touch-sensitive display device, etc.), or any suitable user interface. The system 100 may include other suitable conventional I/O peripherals. The system 100 includes or is operatively coupled to various suitable devices for performing one or more of the aspects as variously described in this disclosure.

The user device 110 and the machine learning prediction system 120 can run any operating system, such as any of the versions of Microsoft® Windows® operating systems, the different releases of the Unix® and Linux® operating systems, any version of the MacOS® for Macintosh computers, any embedded operating system, any real-time operating system, any open source operating system, any proprietary operating system, any operating systems for mobile computing devices, or any other operating system capable of running on user device 110 and the machine learning prediction system 120 and performing the operations described in this disclosure. In an embodiment, the operating system may be run on one or more cloud machine instances.

In other embodiments, the functional components/modules may be implemented with hardware, such as gate level logic (e.g., FPGA) or a purpose-built semiconductor (e.g., ASIC). Still other embodiments may be implemented with a microcontroller having several input/output ports for receiving and outputting data, and several embedded routines for carrying out the functionality described in this disclosure. In a more general sense, any suitable combination of hardware, software, and firmware can be used, as will be apparent.

As will be appreciated in light of this disclosure, the various modules and components of the system, such as the communication application 111, the camera application 112, the AR application 115, the web browser 118 and 123, the communication application 122, or any combination of these, is implemented in software, such as a set of instructions (e.g., HTML, XML, C, C++, object-oriented C, JavaScript®, Java®, BASIC, etc.) encoded on any computer readable medium or computer program product (e.g., hard drive, server, disc, or other suitable non-transitory memory or set of memories), that when executed by one or more processors, cause the various methodologies provided in this disclosure to be carried out. It will be appreciated that, in some embodiments, various functions and data transformations performed by the user computing system, as described in this disclosure, can be performed by similar processors or databases in different configurations and arrangements, and that the depicted embodiments are not intended to be limiting. Various components of this example embodiment, including the system 100, may be integrated into, for example, one or more desktop or laptop computers, workstations, tablets, smart phones, game consoles, set-top boxes, or other such computing devices. Other componentry and modules typical of a computing system, such as processors (e.g., central processing unit and co-processor, graphics processor, etc.), input devices (e.g., keyboard, mouse, touch pad, touch screen, etc.), and operating system, are not shown but will be apparent.

Process Overview

An AR environment is based on the perspective of the user into the real-world scene. For example, if the physical environment is a living room of a house, then the perspective of the user is represented by an image of the room as seen from the user's location within the room. As the user looks or moves around the room, the perspective changes. The image representing the viewpoint at which the user judges the compatibility of the virtual product (3D model) with the surrounding real-world scene is referred to as a viewpoint. The viewpoint includes information previously unavailable through existing web-based techniques for product browsing. The visual data, including one or more viewpoints, includes information about the user's physical world surroundings.

The relevance or attractiveness of any given product to a user may depend on which other products are also shown to the user. For example, certain products (e.g., a coffee table) can be promoted by displaying multiple products together (e.g., a coffee table arranged with a matching sofa and chairs) in a single showroom (e.g., a living room) to simulate an idea of a perfect home. Contextual influence refers to the so-called “one plus one is greater than two” effect created by certain combinations, or bundles, of multiple products that are placed together in a context, such as a living room or other real-world environment, which influences a customer's evaluation and choice. For example, a coffee table may become more appealing to a user when displayed or paired with other pieces of furniture than when the coffee table is displayed alone. Furthermore, certain products may become more appealing to the user when displayed in a real-world environment, such as in a showroom or in the user's actual home. Thus, it is a better experience for customers to see items that are compatible and consistent with each other.

The disclosed techniques can be implemented with respect to any device that can be used for AR, including mobile devices, tablet devices, and desktop devices.

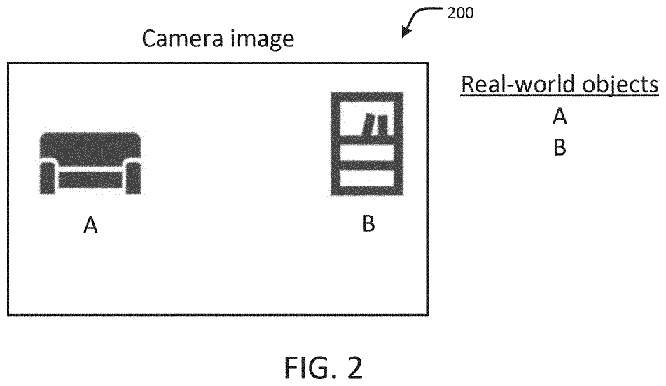

FIG. 2 is a graphic representation of a camera image 200 of a real-world environment, in accordance with an embodiment of the present disclosure. Examples of real-world environments include interior rooms of a house or building, such as a living room, dining room, family room, kitchen, bedroom, hallway, great room, recreation room, sunroom, garage, bathroom, closet, utility room, mudroom, basement, attic, storage room, office, library, breakroom, conference room, lobby, waiting room, or any other interior space. Additional examples of real-world environments include exterior spaces, such as a yard, garden, patio, deck, porch, entryway, breezeway, or any other exterior space. Other examples will be evident in view of this disclosure.

The camera image 200 includes, for example, a view of the physical, real-world objects as captured by the camera and does not contain any virtual products, objects, or images. The camera image 200 can be created when a user points a camera at the real-world environment. In some embodiments, the camera image 200 is a still image (screen shot) of the real-world environment at a given instant. In the example of FIG. 2, the real-world environment is an interior room with various real-world objects including a sofa A and a bookshelf B. The camera image 200 depicts the interior room as it would appear to a person standing in the room from the vantage point of the camera used to capture the image at the time the image was captured.

The camera image 200 can serve as a starting point for a customer who is shopping for additional items to place in the room. The additional items can include, for example, furniture and decorative products that functionally or stylistically complement the sofa A, the bookshelf B, or any other objects that appear in the camera image 200. The disclosed techniques allow the customer to visualize any of those additional items in an AR environment, where virtual representations of those additional items are added to the camera image 200 to appear as if those items exist in the real-world environment.

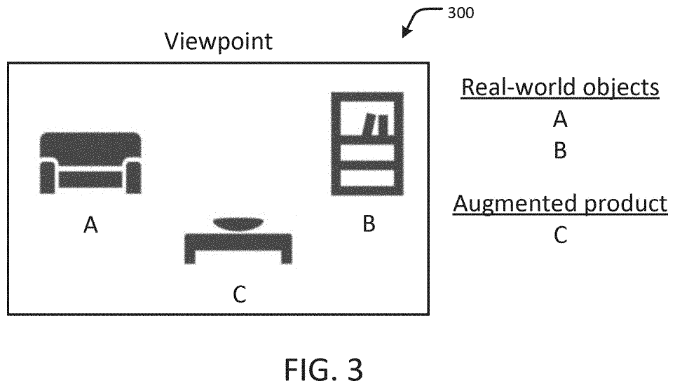

FIG. 3 is a graphic representation of a viewpoint 300 of an AR environment, in accordance with an embodiment of the present disclosure. The viewpoint includes the camera image 200, which is taken at a given instant in time that represents a potential perspective of a customer with respect to the real-world scene in the camera image. In addition to any physical objects and scenes in the camera image, the viewpoint further includes one or more virtual products that are virtually present in the camera image. The virtual products can include specific products that the customer is shopping for or products recommended based on the customer's preferences and the physical, real-world objects in the viewpoint 300. In the example of FIG. 3, the viewpoint 300 includes the interior room with the various real-world objects of FIG. 2, including the sofa A and the bookshelf B. The viewpoint 300 further includes at least one virtual product, such as a table C. The table C can be selected by the customer or recommended to the customer by comparing the sofa A and/or the bookshelf B to an inventory of products for sale, such as an inventory of tables. The viewpoint 300 is thus a virtual visualization of the interior room as it would appear to a person standing in the room from the vantage point of the camera used to capture the image if the virtual product were actually physically present, enabling the customer to evaluate the suitability or desirability of purchasing a physical equivalent of the virtual product.

In the example of FIG. 3, the customer may be shopping specifically for a table to complement the sofa and bookshelf she already owns or has already decided to purchase. The customer may express an interest in finding a table that complements the sofa and/or the bookshelf stylistically or functionally, but she isn't necessarily considering or aware of other products for sale that also complement the sofa and/or the bookshelf. According to certain embodiments, it is desirable to supplement the table with one or more other products for sale. The combination of products represents a bundle of products that are designed to be sold together or that have been previously determined to complement each other in a way that enhances the desirability of the purchasing the individual products. In the example of FIG. 3, although the customer is shopping for a table, and although table C complements the sofa A and/or the bookshelf B, the table C may be more even more enticing to the customer when paired with other types of stylistically or functionally complementary products. For example, the customer may like the table C but not enough to purchase it when viewing it alone. However, by providing an AR visualization of additional (candidate) products that complement the sofa A, the bookshelf B, and/or the table C, the customer may become more interested in purchasing not only the table C, but also one or more of the additional products, such as a table vase and lamp, to go along with the table.

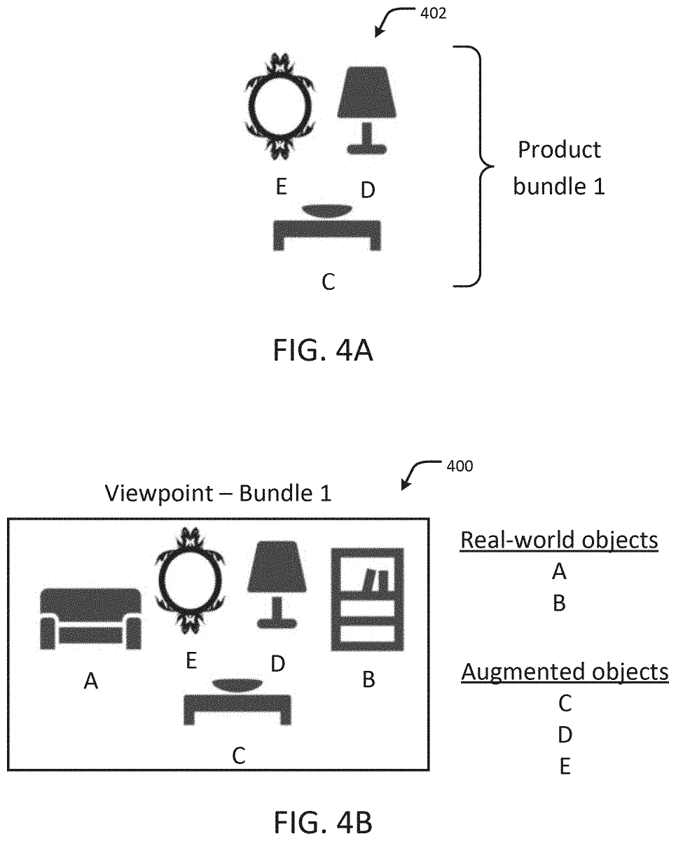

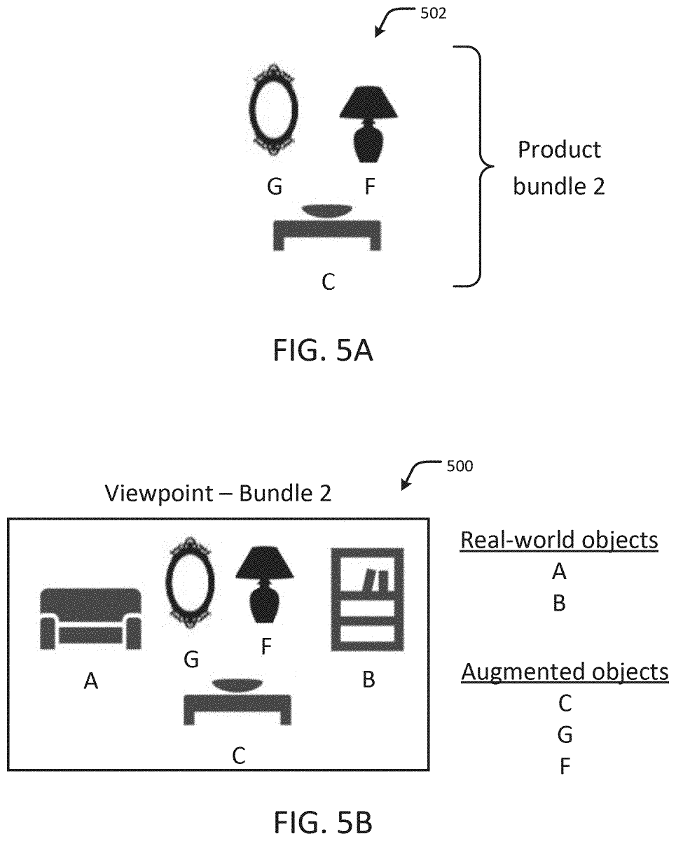

FIG. 4A is a graphic representation of a recommended product bundle 402, in accordance with an embodiment of the present disclosure. The recommended product bundle 402 includes the table C of FIG. 3, which is among the products that the customer is specifically shopping for. The recommended product bundle 402 further includes one or more additional (candidate) recommended products, such as a lamp D and a mirror E. The lamp D and the mirror E are examples of products that are designed to be sold together with the table C or that have been previously determined to complement the table C and can be marketed and sold together as a package of products.

FIG. 4B is a graphic representation of another viewpoint 400 of an AR environment, in accordance with an embodiment of the present disclosure. The viewpoint includes the camera image 200, which is taken at a given instant in time that represents a potential perspective of a customer with respect to the real-world scene in the camera image. In addition to any physical objects and scenes in the camera image, the viewpoint further includes one or more virtual products that are virtually present in the camera image. The virtual products can include specific products that the customer is shopping for and/or products a machine learning algorithm predicts the customer would be interested in based on the customer's preferences that are machine-inferred from the physical, real-world objects or other data augmenting or otherwise included in the viewpoint 400. In the example of FIG. 4B, the viewpoint 400 includes the interior room with the various real-world objects of FIG. 2, including the sofa A and the bookshelf B. The viewpoint 400 further includes at least one virtual product, such as a table C, as well as other products that are bundled with table C, such as the lamp D and mirror E of FIG. 4A. The table C, the lamp D, and/or the mirror E can be machine-selected by comparing the sofa A and/or the bookshelf B to an inventory of products for sale, such as an inventory of tables, lamps, and mirrors. In some cases, the product bundle 402, including the table C, the lamp D, and the mirror E, can be predicted by the machine learning algorithm to include a set of products. The customer may choose to purchase any or all these products. The viewpoint 400 is thus a virtual visualization of the interior room as it would appear to a person standing in the room from the vantage point of the camera used to capture the image if the virtual products in the product bundle 402 were physically present, enabling the customer to evaluate the suitability or desirability of purchasing physical equivalents of the virtual products.

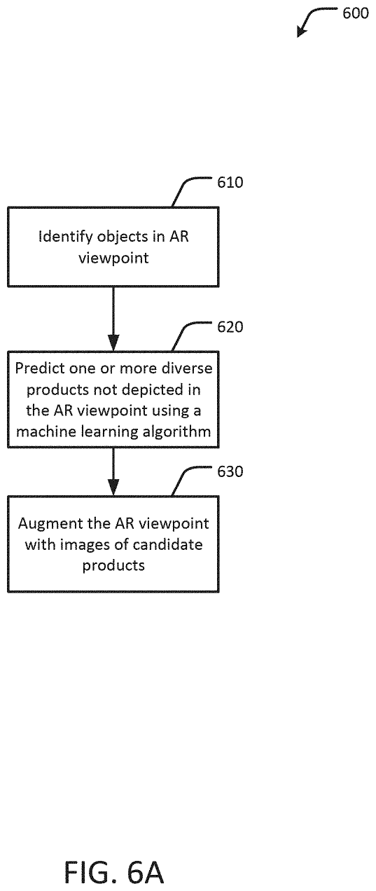

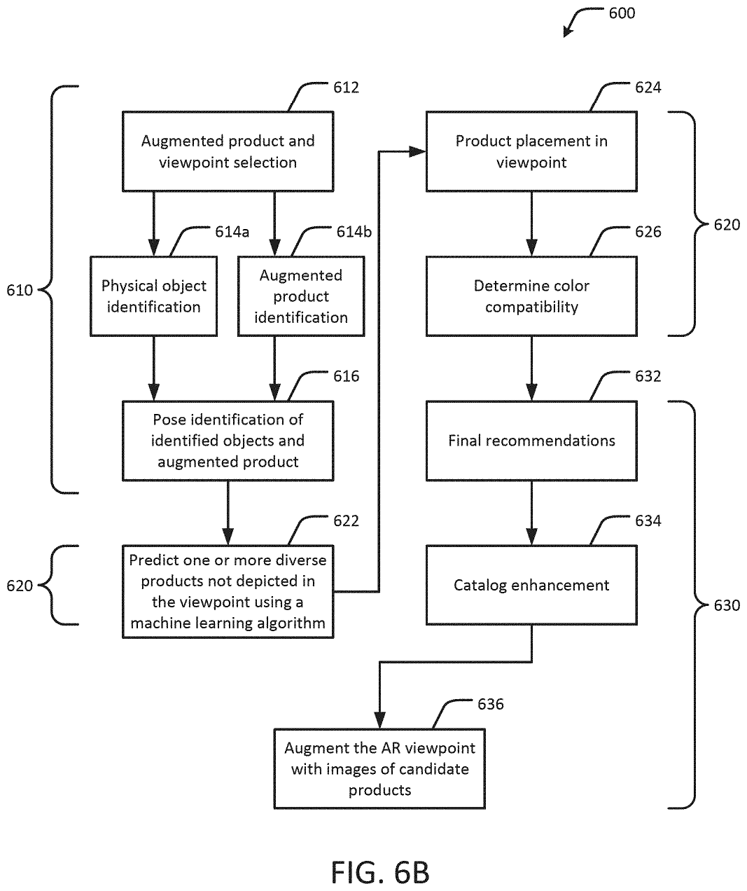

As discussed with respect to FIGS. 4A and 4B, several products can be bundled together for marketing or sales purposes. In some cases, more than one product bundle may exist for a given machine learning prediction. FIG. 5A is a graphic representation of another recommended product bundle 502, in accordance with an embodiment of the present disclosure. The recommended product bundle 502 includes the table C of FIG. 3, which is among the products that the customer is shopping for. As with the recommended product bundle 402 of FIG. 4A, the recommended product bundle 502 further includes one or more additional (candidate) recommended products, such as a lamp F and a mirror G. The lamp F and the mirror G are not necessarily the same as the lamp D and the mirror E in the recommended product bundle 402, which can include one or more different types or categories of products that are designed to be sold together with the table C or that have been previously determined to complement the table C and can be marketed and sold together as a package of products. In this manner, the customer can be provided with more than one recommended product bundle in the AR environment.

FIG. 5B is a graphic representation of yet another viewpoint 500 of an AR environment, in accordance with an embodiment of the present disclosure. The viewpoint includes the camera image 200, which is taken at a given instant in time that represents a potential perspective of a customer with respect to the real-world scene in the camera image. In addition to any physical objects and scenes in the camera image, the viewpoint further includes one or more virtual products that are virtually present in the camera image. The virtual products can include specific products that the customer is shopping for and/or products a machine learning algorithm predicts the customer would be interested in based on the customer's preferences machine-inferred from the physical, real-world objects or other data augmenting or otherwise included in the viewpoint 500. In the example of FIG. 5B, the viewpoint 500 includes the interior room with the various real-world objects of FIG. 2, including the sofa A and the bookshelf B. The viewpoint 500 further includes at least one virtual product, such as a table C, as well as other products that are bundled with table C, such as the lamp F and mirror G of FIG. 5A. The table C, the lamp F, and/or the mirror G can be machine-selected by comparing the sofa A and/or the bookshelf B to an inventory of products for sale, such as an inventory of tables, lamps, and mirrors. In some cases, the product bundle 502, including the table C, the lamp F, and the mirror G, can be predicted by the machine learning algorithm to include a set of products. The customer may choose to purchase any or all these products. The viewpoint 500 is thus a virtual visualization of the interior room as it would appear to a person standing in the room from the vantage point of the camera used to capture the image if the virtual products in the product bundle 502 were physically present, enabling the customer to evaluate the suitability or desirability of purchasing physical equivalents of the virtual products.

It will be understood that the example product bundles 402, 502 can include any number of products of any type or categorization. For example, in addition to or instead of tables, lamps and mirrors, the recommended product bundles can include different types or categories of furniture, decorative elements, artwork, appliances (televisions, radios, refrigerators, ovens, etc.), curtains and drapery, rugs and carpets, or any other products that may be suitable for placement in the real-world environment. The number of combinations of products forming a recommended product bundle is virtually unlimited, as will be appreciated in view of this disclosure.

Methodology

FIGS. 6A and 6B show flow diagrams of an example process 600 for machine learning predictions of recommended products by augmenting a digital image with an image of a recommended product, in accordance with an embodiment of the present disclosure. The process 600 can be implemented, for example, by the system 100 of FIG. 1. Referring to FIG. 6A, the process 600 includes identifying 610 one or more objects in a viewpoint of an AR environment. The viewpoint can include, for example, images of one or more real-world objects and images of one or more virtual products. For example, as shown in FIG. 3, the viewpoint can include real-world objects including the sofa A and the bookshelf B, and virtual product including the table C virtually placed by the user (e.g., the user is shopping for a table to include in a room with an existing sofa and bookshelf). Identifying 610 the objects includes determining a type or categorization of each object, such as “sofa,” “bookshelf,” and “table.”

Based on the identified objects, the process 600 further includes predicting 620 one or more diverse products not depicted in the viewpoint using a machine learning algorithm (as previously explained, these one or more diverse products are referred to herein as being machine-selected or machine-predicted or machine-inferred). Using the objects/products identified in the viewpoint and as well as the object virtually placed by the user, the machine learning algorithm predicts one or more candidate products for inclusion in the augmented reality viewpoint as part of a product bundle recommendation based on the non-availability (not depicted) of those products in the viewpoint as well as their association with the actual objects in the viewpoint and the one or more virtual objects. The process 600 further includes augmenting 630 the AR environment with one or more images of the machine-selected candidate products in the product bundle recommendation to the user.

Various aspects of the process 600 of FIG. 6A are described in further detail with respect to FIG. 6B. Referring to FIG. 6B, identifying 610 the one or more objects in the viewpoint of the AR environment includes selecting 612 a virtual product and a viewpoint. A user initially selects a product image to augment a camera image of a real-world environment the user device 110. The user 101 then uses the AR application 115 along with the camera 117 to insert the product image into the camera image, thus providing a virtual product in the AR environment. The user 101 can, for example, select a product from a digital product catalog. The product can be any product that a user may be interested in, such as a chair, desk, lamp, or other object, that the user 101 intends to place in the real-world environment. The user then selects the product image of the product and uses the AR application 115 to insert the product image into the camera image. As a result, the AR environment includes the virtual product (i.e., the product image the user selected) superimposed on and/or within the camera image generated via the camera 117.

In certain embodiments, the user 101 can scan or photograph an image of the product, such as from a paper catalog. In certain other embodiments, the user 101 can select a digital photograph, such as a photograph of a product stored in a photo library on the data storage unit 116 of the user device 110. For example, the user 101 can take a photograph of a table that the user is interested in purchasing and wishes to visualize in the real-world environment before deciding on the purchase. The image is then used in the AR application. For example, the AR application includes the image used to generate an augmented reality image. In another example, the user 101 retrieves the product image from the photo library and uses the product image with the AR application 115 to generate an augmented reality image, including the photograph as a virtual product, on the user device display 113 of the user device 110.

The user 101 then positions the virtual product within the camera image. After the user 101 selects a product to be virtually placed into the real-world environment depicted on the user device 110, the user 101 utilizes the AR application 115 along with the camera 117 to move the virtual product around within the camera image. For example, after the virtual product is inserted in the camera image, the user 101 can move the user device 110 to position the virtual product in the desired location, orientation, and scale in the camera image. The desired location, for example, corresponds to the location, orientation, and scale in the user's surroundings where the user 101 wishes to place an actual product corresponding to the virtual product. If, for example, the camera image includes a sofa and chair in the user's living room, and the virtual product is of a table that the user 101 is interested in purchasing, the user 101 may move the user device 110 (and the associated camera 117) to position the virtual table in the center of the room as desired.

In certain embodiments, in addition to moving the user device 110 to position the virtual product, the user may move the virtual product to a specific location within the camera image, such as on the top, bottom, left, right, or center of the camera image. For example, the user 101 may drag the virtual product in the user device display 113 and reposition the virtual product within the camera image. If the virtual product is an image of a table, for example, the user may drag the virtual product around in the camera image to a desired location.

In certain embodiments, the user additionally or alternatively provides input to change the orientation of the virtual product in the AR image. In one example, the user 101 flips the virtual product on a horizontal or vertical axis. For example, the user input may rotate the orientation of a chair in a direction determined based on user input. In certain example embodiments, the user additionally or alternatively provides input to change the scale of the virtual product in the AR image. For example, user input can shrink or enlarge the virtual product relative to real objects in the camera image.

After the user selects and positions the virtual product, the viewpoint is selected. A frame of the camera image at which the user assesses the compatibility of the virtual product with the surrounding real objects is referred to as a viewpoint. A potential viewpoint of the user, represented by a camera image of a real-world scene, corresponds to a time instant during the user's AR session. The machine learning prediction system 120 determines the time instant during the use of the AR application 115, for example, when a virtual product is likely to be at a position at which the user would use the product. For example, selecting the viewpoint includes assessing user interactions to determine when the user 101 has settled on a desired position for the virtual product. A lack of changes to the camera image and/or virtual product position for a threshold period of time can be used as an indication of the user having settled on the current position of the virtual product.

A screen shot of the camera image at a given instant is stored in memory or a storage device. Note that the camera frame does not contain the virtual object, whereas the screen shot does include the virtual object. The viewpoint represents the first time instant in the AR session when the user spends more time than a fixed threshold without changing the object's orientation (captured by a binary variable in the existing system) and without moving the device (captured by accelerometer data of the device).

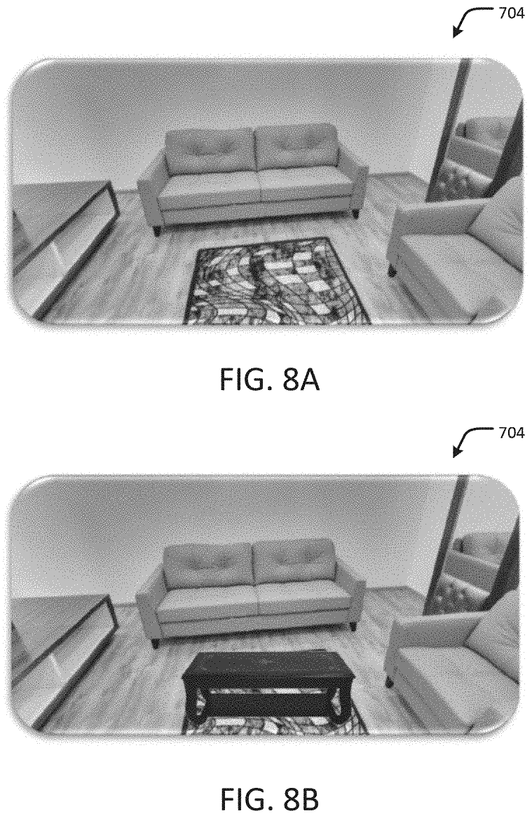

FIG. 7 shows several example potential viewpoints 700, 702, 704 of an AR environment, in accordance with an embodiment of the present disclosure. Each of the viewpoints 700, 702, 704 represents a different perspective of a real-world environment from which to visualize one or more virtual products. In this example, the real-world environment includes a room with a sofa and a chair. Further, the viewpoints 700, 702, 704, depict a virtual table placed in the center of the room. The virtual objects are thus virtually placed in the camera image of the physical objects to produce the AR viewpoint. Each of the viewpoints 700, 702, 704 thus allows the user to visualize the room, with the physical objects (e.g., sofa and chair) and the virtual objects (e.g., table), from different perspectives or viewpoints. One or more of the viewpoints can be used to provide a machine learning prediction of candidate products, where candidate products are displayed with respect to the corresponding viewpoint. The products predicted by the machine learning algorithm include the virtual objects in the viewpoint, as shown in FIG. 7, and candidate objects, such as described in further detail below. Each of the virtual objects in the machine learning prediction may be available for purchase either separately or in any combination.

Viewpoint selection includes determining which of the several viewpoints 700, 702, 704 to use for providing a machine learning prediction in the AR environment. In some embodiments, the viewpoint is the first time instant in the AR session when the user spends more time than a fixed threshold (e.g., 1, 2, 3, 4, 5, 6, 7, 8, 9, 10, or any other number of seconds of fractions thereof) without changing the object's orientation (captured by a binary variable in the existing system) and without moving the device (captured by accelerometer data of the device). For example, if the user changes between the viewpoints 700, 702, 704 to obtain different perspectives of the AR environment and stops changing viewpoints at viewpoint 704 for longer than, for example, five seconds, then viewpoint 704 is selected as the viewpoint for providing the machine learning prediction. The user can resume changing perspectives to select a different viewpoint at any time.

In certain embodiments, the machine learning prediction system 120 receives a series of camera images from the user device 110. As the user 101 changes the position of the virtual product within the camera frame, the machine learning prediction system 120 receives a sequence of image frames representing the user 101 placing the virtual product in the desired location and orientation in the camera image. The received images, for example, may include coordinate data of the user device 110 in space, such as the angles and directions the user 101 moves the user device. The coordinate data may also include information about the user 101 repositioning the virtual product on the screen via a capacitive touch interaction. In certain example embodiments, the images are received as streaming video throughout the user's application session using the AR application 115.

For example, if the virtual product is a table, and the user 101 is positioning the image of the table in the center of the room using the camera 117 and the AR application 115, the machine learning prediction system 120 may receive a series of images from when the user 101 first started positioning the table image in the camera image to the time when the user has finished positioning the table image in the desired location. The received images can include a sequence of image frames in which the table was positioned at different locations with respect to the final, desired location.

The machine learning prediction system 120 identifies a time instant associated with a proper positioning of the virtual product in the camera image. The machine learning prediction system 120 reads the received images and/or any received data, such as via the image processing module 121, to determine when and how long the user moved the user device 110. If the user 101 has positioned the virtual product by moving the virtual product image, the machine learning prediction system 120 can determine when the user 101 stopped moving the image and placed the virtual product in a fixed location and orientation in the camera image. The point in time when the user 101 stops or significantly reduces movement of the user device 110 and/or the virtual product corresponds to the time instant used to select the viewpoint. The time instant corresponds to the time when the user 101 has positioned the virtual product in the desired location in the camera image.

To help ensure that the user 101 has positioned the virtual product in the desired location in the camera image, in certain embodiments the machine learning prediction system 120 determines the time instant as a length of time. The machine learning prediction system 120 determines from the received images and/or associated data the length of time the user device 110 and/or the virtual product were held in roughly in the same position in space (i.e., the user 101 significantly reduced movement the user device 110 and/or the virtual product). In general, the longer amount of time that the user does not move the user device 110 and/or reposition virtual product in the camera image, the more likely it is that the user has positioned the virtual product in the desired location of the camera image. For example, the machine learning prediction system 120 may determine that, after first moving the user device 110 and/or virtual product around erratically, the user 101 then held the user device 110 and/or the virtual product in the same place for about 1, 2, 3, 4, 5, 6, 7, 8, 9, 10, or any other number of seconds of fractions thereof.

In certain embodiments, the machine learning prediction system 120 compares the amount of time that the user does not move the user device 110 and/or reposition virtual product in the camera image to a threshold value. For example, if the image processing module 121 of the machine learning prediction system 120 determines that the user 101 held the user device 110 and/or the virtual product relatively still for 1.0 second, the image processing module 121 compares the 1.0 second to a threshold value. The threshold time value, for example, can be any length of time, such as about 1, 2, 3, 4, 5, 6, 7, 8, 9, 10, or any other number of seconds of fractions thereof.

In some embodiments, the threshold time can be chosen by an operator of the machine learning prediction system 120. For example, the operator can configure the threshold time via the communication application 122 and web-browser 123 to be longer when the operator desires a more precise determination that the user 101 has ceased moving the user device 110 and/or the virtual product. Such longer threshold times, for example, may be useful when the received images are outdoor images and the outdoor setting may include wind, rain, or other elements that affect the user's ability to hold the user device 110 and/or the virtual product still. Conversely, a shorter threshold time may be preferred when the user 101 is indoors. In certain example embodiments, the user 101 may configure the threshold time, such as via the AR application 115.

The machine learning prediction system 120, such a via the image processing module 121, captures a screen shot of the virtual product in the camera image during the time instant when the user 101 has positioned the user device 110 and/or the virtual product in the desired location. For example, if a 1.0 second time instant exceeds a 0.5 second threshold, the machine learning prediction system 120 selects a time during the 1.0 second period to capture the image depicted on the screen of the user device display 113. If the virtual product is of a table, the captured screen shot during the 1.0 second during the 1.0 second, for example, would show the image of the table positioned in the desired location of the camera image.

The machine learning prediction system 120 records the captured screen shot as the viewpoint, for example, in the data storage unit 124 of the machine learning prediction system 120. In embodiments where the AR application 115 performs one or more of the functions of the machine learning prediction system 120, such as capturing the screenshot during the time instant, the screenshot may be recorded in the data storage unit of the user device 116.

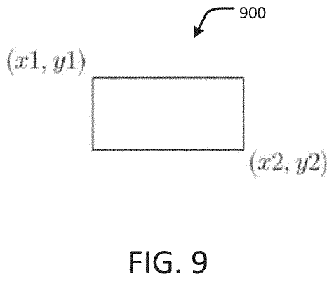

FIGS. 8A and 8B show an example viewpoint selection 704 for recommending product bundles by augmenting a digital image with an image of a recommended product, in accordance with an embodiment of the present disclosure. In FIG. 8A, the viewpoint 704 includes the physical objects (e.g., sofa and chair) and excludes the virtual objects (e.g., table). In FIG. 8B, the viewpoint 704 includes the physical objects (e.g., sofa and chair) and the virtual objects (e.g., table). In this running example, the viewpoint 704 will be used with respect to the description of other portions of the process 600.

The machine learning prediction system 120 determines the location and orientation of the virtual product in the viewpoint. For example, if the virtual product is a table, and the user 101 has positioned the table in the center of the room, the viewpoint will show the table image positioned in the desired location of the user 101. Based on this desired location, the machine learning prediction system 120, such as via the image processing module 121, determines the location and orientation of the virtual table, such as the direction, angle, and/or coordinates of the virtual chair in the viewpoint. This virtual product position corresponds to the user's desired location of the product depicted in the virtual product of the viewpoint. The position of the virtual product can serve as a basis for placing other recommended product images. For example, if the virtual product is a table, then images of other recommended products, such as a lamp and a vase, can be placed on or near the table.

The location and orientation of the virtual product in the viewpoint can be determined by various techniques. For example, the AR application 115 can capture the coordinates of the camera 117 of the user device 110 throughout the user's application session. The AR application 115 can then can store, in the data storage unit of 116 of the user device 110, the location and orientation only at the time point when the viewpoint is selected, thus providing a deterministic solution to identifying the location and orientation of the virtual product. In embodiments where the machine learning prediction system 120 functions at least in part separately from the AR application 115, the AR application 115 can then send the stored information to the machine learning prediction system 120 via the network 105.

In certain example embodiments, the location, orientation, and/or scale of the virtual product can be determined using example images of objects of the same type with known locations and/or orientations. For example, the machine learning prediction system 120 may use a set of training images that contain images of objects, with each of the objects positioned in multiple different ways. The machine learning prediction system 120 can create a model or otherwise learn from the training images. For example, the machine learning prediction system 120 can determine features of an image of a table that indicate the chair being in a given orientation. The machine learning prediction system 120 can create a different model for different types of products, for example, one model for chairs, one model for tables, one model for desks, and models for other types of products. For instance, if the virtual product is a table, the class of training images can include images of tables on a monochromatic background.

Referring again to FIG. 6B, identifying 610 the one or more objects in the viewpoint of the AR environment further includes identifying 614a one or more real-world objects present in the selected viewpoint (e.g., the viewpoint 704) and identifying 614b one or more virtual objects present in the selected viewpoint. It is important to note that both the real-world objects and the virtual objects in the viewpoint are identified, in contrast to some existing techniques where only the real-world objects in the viewpoint are identified using the disclosed techniques. In this manner, the combination of real-world objects and virtual objects can be used to generate recommendations of product bundles that include additional objects not present in the camera image or in the initial viewpoint before the recommendations are generated, as well as recommendations of product bundles that include additional objects that are complementary to objected already included in the camera image or in the initial viewpoint before the recommendations are generated. In some embodiments, a region-based Convolutional Neural Network (R-CNN) is used to detect real-world and virtual objects in the selected viewpoint. Each of the identified objects, including the real-world and virtual objects, is represented by a bounding box, which is an object proposal defined by two coordinate pairs in a two-dimensional plane, along with a confidence score and a class label.

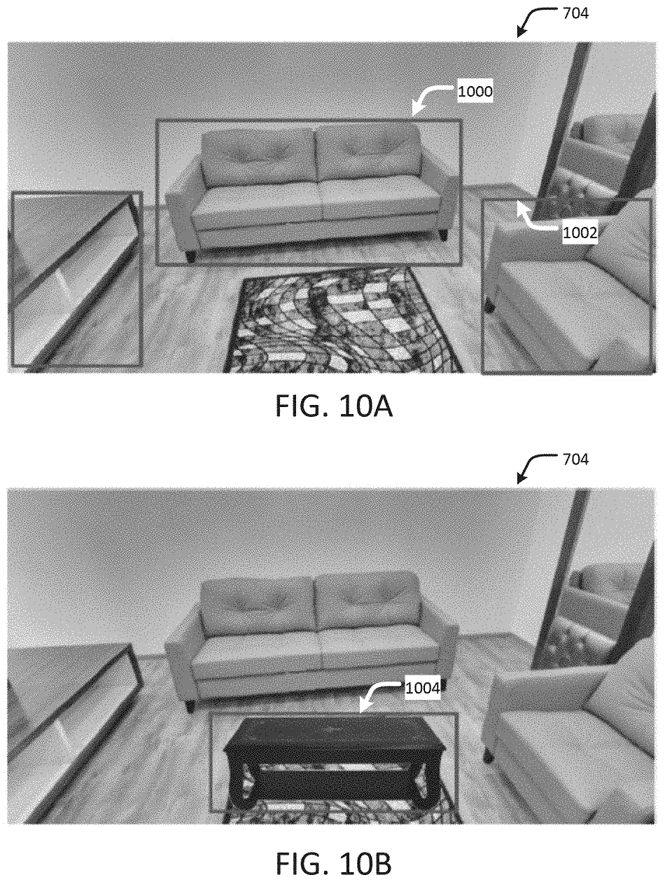

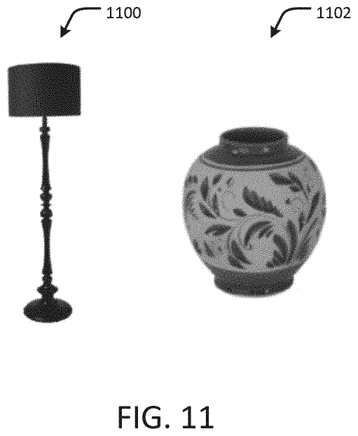

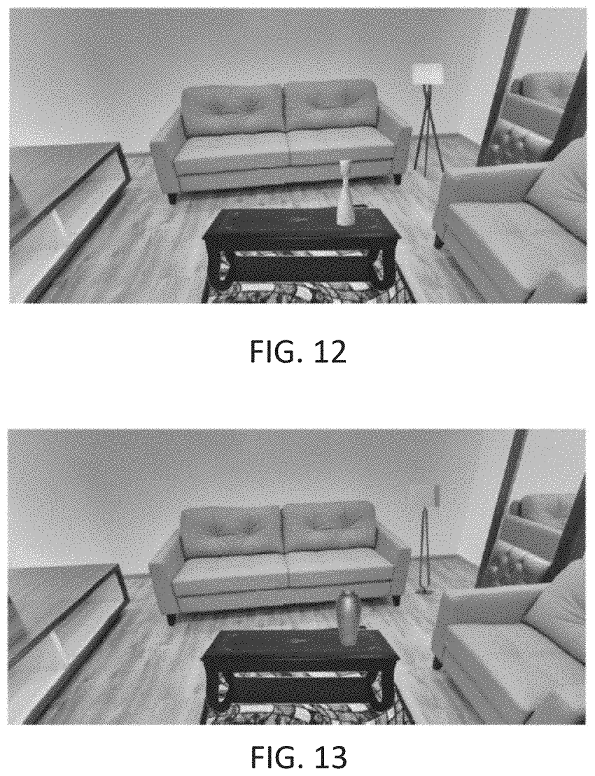

FIG. 9 shows an example bounding box 900 with coordinate pairs (x1, y1) and (x2, y2), in accordance with an embodiment. For example, in the above-mentioned camera frame of the viewpoint 704, there will be different bounding boxes corresponding to different objects. FIG. 10A shows the example viewpoint 704 including the physical objects (e.g., sofa and chair) and excluding the virtual objects (e.g., table). FIG. 10A further shows bounding boxes 1000, 1002 representing the physical objects. FIG. 10B shows the example viewpoint 704 including the physical objects (e.g., sofa and chair) and the virtual objects (e.g., table). FIG. 10B further shows bounding box 1004 representing the virtual objects.

In some embodiments, the bounding box for each identified object is generated using a Region Proposal Network (RPN) that shares full-image convolutional features is used with the detection network (for example, R-CNN), thus enabling nearly cost-free region proposals as represented by the bounding boxes. An RPN is a fully convolutional network that simultaneously predicts object bounds and so-called objectness scores at each position in the viewpoint. The RPN is trained end-to-end to generate high-quality region proposals, which are used by Fast R-CNN for detection. Further, the network is enhanced by merging RPN and Fast R-CNN into a single network by sharing their convolutional features, and by using neural networks with attention mechanisms, the RPN component can tell the unified network where to look for the various objects in the viewpoint.

For example, let B be a set of all bounding boxes and n be the number of bounding boxes identified in the viewpoint:

B={b₁,b₂, . . . ,bₙ}

Each bounding box bᵢ has a corresponding object label lᵢ and confidence score cᵢ.

Referring again to FIG. 6B, identifying 610 the one or more objects in the viewpoint of the AR environment further includes identifying 616 a pose, or orientation, of each real-world and virtual objects identified in the selected viewpoint (e.g., the viewpoint 704). It is important to note that the poses of the real-world objects and of the virtual objects in the viewpoint are identified in contrast to some existing techniques where only the poses of real-world objects in the viewpoint are identified using the disclosed techniques. To create a product bundle recommendation, the pose of the identified objects (real-world and virtual) is identified in the selected viewpoint.

In some embodiments, correlation filters (CF) can be used in the bounding boxes of the identified objects to figure out their pose in the viewpoint with respect to camera coordinates. CF-based training uses images containing a class, such as a class of “table” representing table products. The class includes a predetermined number of images of tables on a monochromatic background where each table in the class is represented by images of the table in multiple different orientations or poses. In this manner, a virtual representation of the table can be displayed in a pose that closely corresponds to the identified pose of one or more of the real-world and virtual objects. Correlation filters can be used to control the shape of the cross-correlation output between the image and the filter by minimizing the average Mean Square Error (MSE) between the cross-correlation output and the ideal desired correlation output for an authentic (or impostor) input image. By explicitly controlling the shape of the entire correlation output, unlike traditional classifiers which only control the output value at the target location, CFs achieve more accurate local estimation.

For example, using N training images, the CF design problem is posed as an optimization problem:

$${min}_{f} \frac{1}{N} {\sum }_{i = 1}^{N} {‖ {x}_{i} ⊗ f - {g}_{i} ‖}_{2}^{2} + λ {‖ f ‖}_{2}^{2}$$

where ⊗ denotes the convolution operation, xᵢ denotes the i^{th} image, f is the CF template (It is spatial-frequency array, an equivalent of CF template in the image domain) and g is the desired correlation output for the i^{th} image and A is the regularization parameter.

Solving the above optimization problem results in the following closed form expression for the CF,

$$\hat{f} = {[ λ I + \frac{1}{N} {\sum }_{i = 1}^{N} {\hat{X}}_{i}^{*} \hat{{X}_{i}} ]}^{- 1} [ \frac{1}{N} {\sum }_{i = 1}^{N} {\hat{X}}_{i}^{*} {\hat{g}}_{i} ]$$

Where \hat{x}_{ι} denotes the Fourier transform of xᵢ, where \hat{X}_{ι} denotes the diagonal matrix whose diagonal entries are the elements of \hat{x}_{ι}, where * denotes conjugate transpose, and where I is the identity matrix of appropriate dimensions. By using the above solution, one can find out the approximate pose of a three-dimensional (3D) object in a two-dimensional (2D) image, such as the camera image of the real-world environment or the viewpoint including the real-world environment and any virtual objects.

Alternatively, in some embodiments, the location and orientation of the virtual object within the AR environment can be captured throughout the application session, which provides a deterministic result rather than a probabilistic one. For example, the AR environment can generate a virtual object at a certain set of 2D coordinates using an image of the object that corresponds to a certain pose (orientation of the object). A table can be generated within a region bounded by coordinates (x1, y1), (x2, y2), using an image that represents a pose p of the table, such as a top-down view, a side view, a three-quarter view, and so forth. The coordinates and pose of the virtual object can be changed by the user and recorded. In this manner, the pose of the virtual object is deterministic rather than probabilistic using, for example, a CF to determine the pose of the object from the image.

Referring again to FIG. 6B, predicting 620 the one or more products for bundle creation includes predicting 622 which of one or more products from a catalog or inventory of products are to be included in a product bundle recommendation using the machine learning algorithm. As previously explained, these one or more products from to be included in a product bundle are herein referred to as being machine-selected or machine-predicted or machine-inferred. To create a product bundle recommendation that is intuitive and helpful to the user, images of the predicted products are located at appropriate positions in the viewpoint with appropriate pose and scale to provide the visualization of the recommended products in the AR environment.

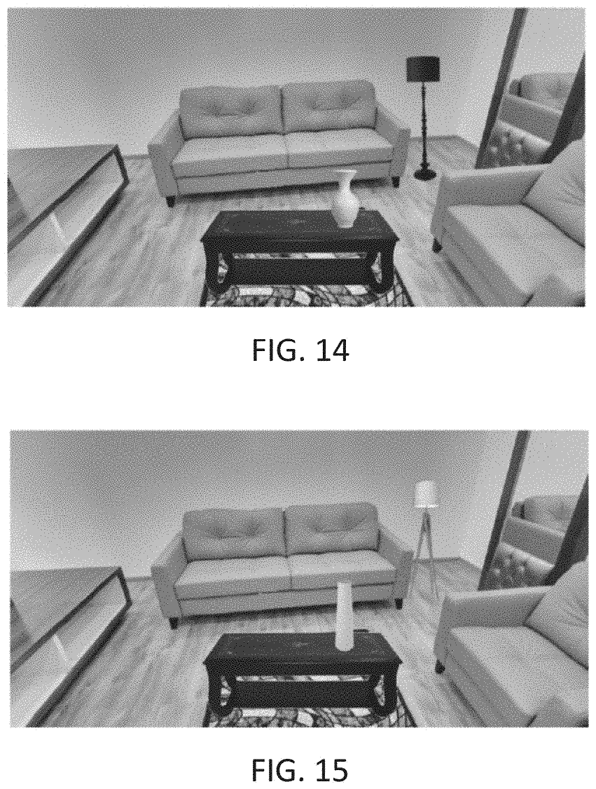

FIG. 11 shows two example objects (products) 1100, 1102 that can be predicted 622 by the machine learning algorithm for inclusion in the product bundle recommendation, in accordance with an embodiment of the present disclosure. In this example use-case, the objects include a lamp 1100 and a vase 1102. Based on the actual one or more objects/products identified in the viewpoint and the one or more virtual objects placed in the environment by the user, one or more additional such products 1100, 1102 are machine-selected based on the non-availability of their respective types in the viewpoint as well as their association with the actual and virtual objects in the AR viewpoint. The machine selected products 1100, 1102 are then augmented into the AR viewpoint and thus included in the product bundle recommendation.

For example, a user places a virtual center table in a living room with other actual objects such as sofa and armchair. Existing e-commerce recommendation engines use machine learning algorithms to predict product recommendations of other sofa and armchair models. An example e-commerce recommendation engine is described by Tao Zhu et al, “Bundle Recommendation in eCommerce” (SIGIR'14, Jul. 6-11, 2014). However, and as will be appreciated in light of this disclosure, due to availability of other valuable information that can be inferred from the viewpoint, a more diverse set of candidate products can be predicted using machine learning algorithms, including (1) products that are not depicted or otherwise available in the viewpoint, as well as (2) products that have good association with existing objects in the viewpoint. In this manner, the techniques provided herein can be used to supplement existing machine learning techniques to provide a richer set of product recommendations.

Referring still to FIG. 6B, predicting 620 the one or more products for bundle creation further includes augmenting 624 images of the selected products (candidate products) from the machine learning prediction into the selected viewpoint (e.g., the viewpoint 704). The machine learning prediction is used to augment the viewpoint with images of one or more recommended (candidate) products at the appropriate location with appropriate pose and scale. Thus, the pose of the identified objects and the virtual object in the viewpoint is used so that the recommended products can be embedded in the viewpoint at the appropriate location with appropriate pose and scale. The machine learning prediction system 120 creates a set of recommendation images in which a candidate product image of a candidate product is virtual product into the viewpoint. In certain embodiments, the machine learning prediction system 120 uses the determined location, orientation, and/or scale of the virtual product to augment images of the AR viewpoint with images of the recommended products.

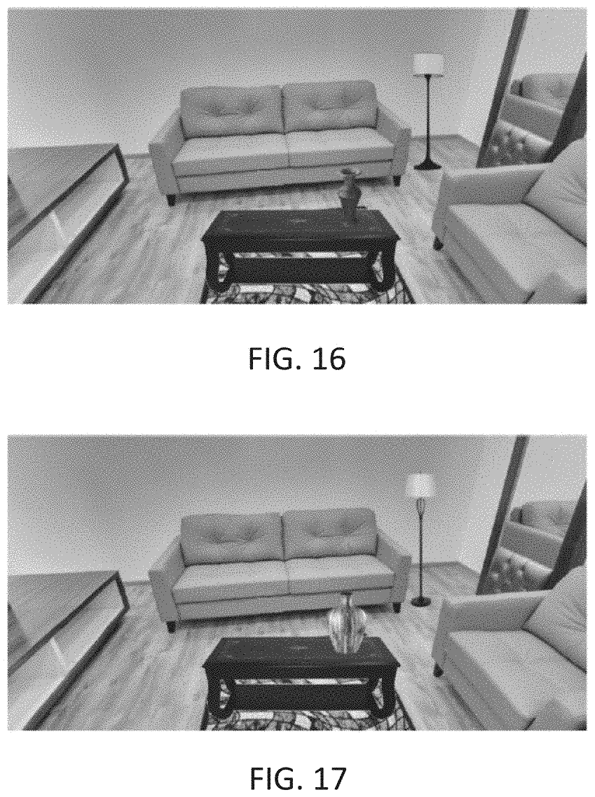

FIGS. 12, 13, 14, 15, 16 and 17 are example viewpoints in an AR environment that include images of the recommended products placed into the viewpoint. In 12, 13, 14, 15, 16 and 17, the viewpoint includes images of different types or categories of virtual products, including a table, a table vase, and a lamp. However, while the virtual table is the same in each viewpoint, the table vase and lamp are different models in each viewpoint. This provides the user with the ability to visualize and compare different products in the AR environment prior to making a purchase.

In certain embodiments, the images of the products and other objects in the augmented AR viewpoint can be normalized such that they have the same reference in terms of the rotation, translation, and scale. For example, known applications and image enhancement programs can be used to normalize the location/orientation/scale of the recommended products placed into the viewpoint. Plane detection technologies, such as in Augmented Reality Software Development Kits can be used to detect planar surfaces (for example, horizontal surfaces) on the objects for appropriate placement of those products. Such plane detection technologies look for clusters of feature points that appear to lie on common horizontal surfaces, like floor, tables and desks, and makes these surfaces available to the AR device as planes for locating other objects. Locations adjacent to identified objects are selected from the viewpoint for the placement of products. The pose and scale of the adjacent object is used to select the appropriate pose and scale of the candidate product.

In some embodiments, locations adjacent to identified real-world and virtual objects are selected from the viewpoint for placement of products. For example, a Region Proposal Network can be used to compute the objectness score at such locations to avoid locations which already have objects present to prevent objects from overlapping the same location in the AR environment. For example, a virtual lamp can be placed at a location in the viewpoint such that the lamp appears to sit on a top surface of a table. The pose and scale of the adjacent object is used to select the appropriate pose and scale of the candidate product.

Referring again to FIG. 6B, predicting 620 the one or more products for bundle creation includes determining 626 the color compatibility of one or more of the recommended products (candidate products) augmented into the AR viewpoint (e.g., the viewpoint 704). The color compatibility is a measure of how the colors of the objects in the viewpoint relate to the color of the background of the viewpoint. For example, a theme of multiple colors (represented in hex codes) can be extracted from the virtual object images associated with each recommendation. The theme is then passed to a lasso regression model, which generates a rating to the theme on a scale of 1-5, where the weights are learned from large-scale, crowd-sourced data. The score is normalized to lie in a range [0, 1] denoting the virtual object's color compatibility with the background.

In further detail, to calculate the compatibility measure, we first extract a theme of five colors from the images created in the previous step. This step is done to get a sense of the dominant colors that may attract the attention of the customer. An objective function is used:

$${max}_{\text{?}} α \cdot r ( t ) - \frac{1}{N} {\sum }_{\text{?}} {min}_{1 \leq k \leq 5} ( max ( {‖ {c}_{i} - {t}_{k} ‖}_{2} , σ ) ) - \frac{τ}{M} {max}_{k} {\sum }_{j ∈ N ( {t}_{k} )} max ( {‖ {c}_{j} - {t}_{k} ‖}_{2} , σ )$$

$$\text{?} \text{indicates text missing or illegible when filed}$$

Where, r(t) is the rating of theme t, cᵢ is a pixel color, tₖ is a theme color, N is the number of pixels, σ is the threshold for distance allowed, and α and τ are the learning rate parameters. The first term of the objective function measures the quality of the extracted theme. The second term penalizes dissimilarity between each image pixel cᵢ and the most similar color tₖ in the theme. The third term penalizes dissimilarity between theme colors tₖ and the M most similar image pixels N(t) to prevent theme colors from drifting from the image. The model uses, for example, M=N/20, τ=0.025, α=3 and σ=5. A DIRECT sampling algorithm can be used for optimization, since it performs a deterministic global search without requiring initialization. Instead, the DIRECT algorithm samples points in the domain and uses the information to decide where to search next. Next, each theme of colors is scored using a regression model given. First, a vector of 326 features including sorted colors, differences, PCA features, hue probability, hue entropy, etc., is derived from an input theme t. Feature selection is then performed to determine the most relevant features. LASSO, a regression model with an L1 norm on the weights, is used on the resulting feature vector y(t). This method automatically selects the most relevant features, since solutions have many zero weights. The model rates a theme on a scale of 1-5. The LASSO regressor is a linear function of the features:

r(t)=w^{T}y(t)+b

learned with L1 regularization.

$${min}_{w , b} {\sum }_{i} {( {w}^{T} {y}_{i} + b - {r}_{i} )}^{2} + λ {‖ w ‖}_{1}$$

Here, r(t) is the predicted rating of the input theme, and w, b are the learned parameters. For each image corresponding to a machine learning prediction, a theme is extracted and passed through this regression model. For the i^{th} candidate, if tᵢ is the extracted theme, then a normalized score βᵢ denoting its color compatibility is associated with the viewpoint on a scale of 0-1 as follows:

$${β}_{i} = \frac{r ( {t}_{i} ) - 1}{5 - 1}$$

The user-based ratings range from 1 to 5. For standardization purposes, the score involves subtracting the rating by minimum possible rating and then dividing it by the difference of maximum possible rating and minimum possible rating (i.e., 5-1).

Referring again to FIG. 6B, augmenting 630 the AR viewpoint with one or more images of the candidate products in the product bundle recommendation to the user in the AR environment generating 632 final product bundle recommendations. The recommendations are ranked (e.g., sorted decreasingly) according to the color compatibility score. A predetermined number of top ranked embedded images are selected to be included in the final product bundle recommendation.

According to some embodiments, the AR device might not have a high-resolution camera, or the viewpoint may include irrelevant background. To this end, augmenting 630 the AR viewpoint with one or more images of the candidate products in the product bundle recommendation includes enhancing 634 the images by contrasting, sharpening, and/or automatically cropping the images using available online tools. The contrast of each image is manipulated to make the recommended model distinguishable with respect to other objects in the user's viewpoint. The images are then sharpened for emphasizing texture and drawing the customer's focus. Sharpening is required because camera lenses generally blur an image to some degree, and this requires correction. Finally, auto-cropping is performed to preserve the most important visual parts of the images, and to remove some undesired background that is irrelevant. The enhanced images can then be sent to a customer thorough media, such as emails or push notifications, or used to augment 636 the AR viewpoint of the user or of a different user (different customer).

According to some embodiments, the product bundle recommendation can be sent to other potential customers via various marketing channels such as emails and push notifications. For example, the product bundle recommendations can be used to augment 636 the AR viewpoint of other potential customers who have expressed interest or potentially have an interest in any of the recommended products in the bundle, as inferred from that AR viewpoint. These customers can then use an AR device to visualize the product bundle recommendation.

The disclosed techniques provide a framework for a unique machine learning system that leverages information such as presence of objects in the user's viewpoint to augment an AR viewpoint with images of products that have high association with the objects in the viewpoint and are absent in the viewpoint by positioning them in the viewpoint image at the appropriate position with appropriate pose and scale. Thus, hidden information available via AR applications can be used by the machine learning algorithm to augment the AR viewpoint with additional product recommendations, which is not possible using existing techniques. Machine learning predictions in prior art involve web-based browsing/purchasing data and are an inferior choice for AR systems due to non-utilization of relevant and hidden information in the AR viewpoint.

The disclosed techniques further provide a technology to provide machine learning predictions of recommended products to customers by creating personalized catalogues (set of images) of products augmented in the user's AR viewpoint at the appropriate position with appropriate pose and scale. Predicting product recommendations using existing techniques involves using only the product images. Whereas, images generated using the disclosed techniques contain the products augmented with the background scene that provides contextual influence for the product bundles and enhances the purchasing propensity.

The disclosed techniques further provide a color compatibility score of the candidate recommendation product with the background in the viewpoint.

Since the viewpoint (image) comes from the user's device, it may be necessary to enhance them for presentation to other customers. As such, the disclosed techniques enhance the catalogue images based on sharpness, contrast and removal of irrelevant background for presenting recommendations to customers.

### ADDITIONAL EXAMPLES

Numerous embodiments will be apparent in light of the present disclosure, and features described herein can be combined in any number of configurations. One example embodiment provides a computer-implemented method for providing a machine learning prediction of a recommended product to a user using augmented reality. The method includes identifying, by at least one processor, both a real-world object and a virtual product captured in an augmented reality viewpoint of the user, the viewpoint including a camera image of the real-world object and an image of the virtual product, the image of the virtual product being inserted into the camera image of the real-world object; predicting, by the at least one processor using a machine learning algorithm, a candidate product from a set of recommendation images, the predicting based on the predicted candidate product being (1) a different product type than the identified virtual product and complementary to the identified virtual product, or (2) a variant of the identified virtual product and complementary to one or more other features captured in the augmented reality viewpoint; and augmenting, by the at least one processor, the augmented reality viewpoint with an image of the predicted candidate product, thereby providing an image of the recommended product to the user. In some cases, the method includes selecting, by the at least one processor, the augmented reality viewpoint of the user at a time instant that occurs after the user spends more time than a fixed threshold without changing an orientation of the virtual product or an orientation of the camera image, where the image of the predicted candidate product is augmented into the selected augmented reality viewpoint after the fixed threshold has expired. In some cases, the method includes determining, by the at least one processor, a pose of the virtual product identified in the augmented reality viewpoint, where predicting the candidate product is further based on the pose of the virtual product. In some cases, the method includes determining, by the at least one processor, a color compatibility of the predicted candidate product in relation to a background color of the viewpoint, where predicting the candidate product is further based on the color compatibility. In some such cases, the method includes ranking, by the at least one processor, the predicted candidate product based on the color compatibility, where predicting the candidate product is further based on the ranking. In some cases, the method includes enhancing, by the at least one processor, the image of the predicted candidate product by contrasting, sharpening, and/or automatically cropping the image of the predicted candidate product. In some cases, the method includes augmenting, by the at least one processor, an augmented reality viewpoint of a different user with the image of the predicted candidate product.

Another example embodiment provides a computer program product including one or more non-transitory computer readable mediums having instructions encoded thereon that when executed by one or more processors cause a process to be carried out for providing a machine learning prediction of a recommended product to a user using augmented reality. The process includes identifying both a real-world object and a virtual product captured in an augmented reality viewpoint of the user, the viewpoint including a camera image of the real-world object and an image of the virtual product, the image of the virtual product being inserted into the camera image of the real-world object; predicting, using a machine learning algorithm, a candidate product from a set of recommendation images based on a type of the identified virtual product, a type of the candidate product being different type from the type of the identified virtual product; and augmenting the augmented reality viewpoint with an image of the predicted candidate product, thereby providing an image of the recommended product to the user. In some cases, the process includes selecting, by the at least one processor, the augmented reality viewpoint of the user based on a first time instant when the user spends more time than a fixed threshold without changing an orientation of the virtual product or an orientation of the camera image, where the image of the predicted candidate product is augmented into the selected augmented reality viewpoint. In some cases, the process includes determining, by the at least one processor, a pose of the virtual product identified in the augmented reality viewpoint, where predicting the candidate product is further based on the pose of the virtual product. In some cases, the process includes determining a color compatibility of the predicted candidate product in relation to a background color of the augmented reality viewpoint, where predicting the candidate product is further based on the color compatibility. In some such cases, the process includes ranking the predicted candidate product based on the color compatibility, where predicting the candidate product is further based on the ranking. In some cases, the process includes enhancing the image of the predicted candidate product by contrasting, sharpening, and/or automatically cropping the image of the predicted candidate product. In some cases, the process includes augmenting, by the at least one processor, an augmented reality viewpoint of a different user with the image of the predicted candidate product.

Yet another example embodiment provides a system for providing a machine learning prediction to a user using augmented reality. The system includes a means for identifying a real-world object and a virtual product in an augmented reality viewpoint of the user, the viewpoint including a camera image of the real-world object and an image of the virtual product, the image of the virtual product being inserted into the camera image of the real-world object; a means for predicting a candidate product from a set of recommendation images based on a type of the identified virtual product, a type of the predicted candidate product being different type from the type of the identified virtual product; and a means for augmenting the augmented reality viewpoint with an image of the predicted candidate product, thereby providing an image of the recommended product to the user. In some cases, the system includes a means for selecting the augmented reality viewpoint of the user based on a first time instant when the user spends more time than a fixed threshold without changing an orientation of the virtual product or an orientation of the camera image, where the image of the predicted candidate product is augmented into the selected augmented reality viewpoint. In some cases, the system includes a means for determining a pose of the virtual product identified in the selected augmented reality viewpoint, where predicting the predicted candidate product is further based on the pose of the virtual object. In some cases, the system includes a means for determining a color compatibility of the predicted candidate product in relation to a background color of the augmented reality viewpoint, where predicting the predicted candidate product is further based on the color compatibility. In some cases, the system includes a means for ranking the predicted candidate product based on the color compatibility, where predicting the predicted candidate product is further based on the ranking. In some cases, the system includes a means for enhancing the image of the predicted candidate product by contrasting, sharpening, and/or automatically cropping the image of the predicted candidate product.

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims.

What is claimed is:

1. A computer-implemented method for providing a machine learning prediction of a recommended product to a user using augmented reality, the method comprising:
identifying, by at least one processor, both a real-world object and a virtual product captured in an augmented reality viewpoint of the user, the viewpoint including a camera image of the real-world object and an image of the virtual product, the image of the virtual product being inserted into the camera image of the real-world object;
predicting, by the at least one processor using a machine learning algorithm, a candidate product from a set of recommendation images, the predicting based on the predicted candidate product being
(1) a different product type than the identified virtual product and complementary to the identified virtual product, or
(2) a variant of the identified virtual product and complementary to one or more other features captured in the augmented reality viewpoint; and
augmenting, by the at least one processor, the augmented reality viewpoint with an image of the predicted candidate product, thereby providing an image of the recommended product to the user.

2. The method of claim 1, further comprising selecting, by the at least one processor, the augmented reality viewpoint of the user at a time instant that occurs after the user spends more time than a fixed threshold without changing an orientation of the virtual product or an orientation of the camera image, wherein the image of the predicted candidate product is augmented into the selected augmented reality viewpoint after the fixed threshold has expired.

3. The method of claim 1, further comprising determining, by the at least one processor, a pose of the virtual product identified in the augmented reality viewpoint, wherein predicting the candidate product is further based on the pose of the virtual product.

4. The method of claim 1, further comprising determining, by the at least one processor, a color compatibility of the predicted candidate product in relation to a background color of the viewpoint, wherein predicting the candidate product is further based on the color compatibility.

5. The method of claim 4, further comprising ranking, by the at least one processor, the predicted candidate product based on the color compatibility, wherein predicting the candidate product is further based on the ranking.

6. The method of claim 1, further comprising enhancing, by the at least one processor, the image of the predicted candidate product by contrasting, sharpening, and/or automatically cropping the image of the predicted candidate product.

7. The method of claim 1, further comprising augmenting, by the at least one processor, an augmented reality viewpoint of a different user with the image of the predicted candidate product.

8. A computer program product including one or more non-transitory computer readable mediums having instructions encoded thereon that when executed by one or more processors cause a process to be carried out for providing a machine learning prediction of a recommended product to a user using augmented reality, the process comprising:
identifying both a real-world object and a virtual product captured in an augmented reality viewpoint of the user, the viewpoint including a camera image of the real-world object and an image of the virtual product, the image of the virtual product being inserted into the camera image of the real-world object;
predicting, using a machine learning algorithm, a candidate product from a set of recommendation images based on a type of the identified virtual product, a type of the candidate product being different type from the type of the identified virtual product; and
augmenting the augmented reality viewpoint with an image of the predicted candidate product, thereby providing an image of the recommended product to the user.

9. The non-transitory computer readable medium of claim 8, wherein the process further comprises selecting, by the at least one processor, the augmented reality viewpoint of the user based on a first time instant when the user spends more time than a fixed threshold without changing an orientation of the virtual product or an orientation of the camera image, wherein the image of the predicted candidate product is augmented into the selected augmented reality viewpoint.

10. The non-transitory computer readable medium of claim 8, wherein the process further comprises determining, by the at least one processor, a pose of the virtual product identified in the augmented reality viewpoint, wherein predicting the candidate product is further based on the pose of the virtual product.

11. The non-transitory computer readable medium of claim 8, wherein the process further comprises determining a color compatibility of the predicted candidate product in relation to a background color of the augmented reality viewpoint, wherein predicting the candidate product is further based on the color compatibility.

12. The non-transitory computer readable medium of claim 11, wherein the process further comprises ranking the predicted candidate product based on the color compatibility, wherein predicting the candidate product is further based on the ranking.

13. The non-transitory computer readable medium of claim 8, wherein the process further comprises enhancing the image of the predicted candidate product by contrasting, sharpening, and/or automatically cropping the image of the predicted candidate product.

14. The non-transitory computer readable medium of claim 8, wherein the process further comprises augmenting, by the at least one processor, an augmented reality viewpoint of a different user with the image of the predicted candidate product.

15. A system for providing a machine learning prediction to a user using augmented reality, the system comprising:
a means for identifying a real-world object and a virtual product in an augmented reality viewpoint of the user, the viewpoint including a camera image of the real-world object and an image of the virtual product, the image of the virtual product being inserted into the camera image of the real-world object;
a means for predicting a candidate product from a set of recommendation images based on a type of the identified virtual product, a type of the predicted candidate product being different type from the type of the identified virtual product; and
a means for augmenting the augmented reality viewpoint with an image of the predicted candidate product, thereby providing an image of the recommended product to the user.

16. The system of claim 15, further comprising a means for selecting the augmented reality viewpoint of the user based on a first time instant when the user spends more time than a fixed threshold without changing an orientation of the virtual product or an orientation of the camera image, wherein the image of the predicted candidate product is augmented into the selected augmented reality viewpoint.

17. The system of claim 15, further comprising a means for determining a pose of the virtual product identified in the selected augmented reality viewpoint, wherein predicting the predicted candidate product is further based on the pose of the virtual object.

18. The system of claim 15, further comprising a means for determining a color compatibility of the predicted candidate product in relation to a background color of the augmented reality viewpoint, wherein predicting the predicted candidate product is further based on the color compatibility.

19. The system of claim 18, further comprising a means for ranking the predicted candidate product based on the color compatibility, wherein predicting the predicted candidate product is further based on the ranking.

20. The system of claim 15, further comprising a means for enhancing the image of the predicted candidate product by contrasting, sharpening, and/or automatically cropping the image of the predicted candidate product.
